(19) United States
(12) Patent Application Publication
(10) Pub. No.: US 2018/0089085 A1
(43) Pub. Date: Mar. 29, 2018

(54) REUSING TRAINED PREFETCHERS

(71) Applicant: QUALCOMM Incorporated, San Diego, CA (US)

(72) Inventors: Vignyan Reddy KOTHINTI NARESH, Morrisville, NC (US); Gregory Michael WRIGHT, Chapel Hill, NC (US)

(21) Appl. No.: 15/274,615

(22) Filed: Sep. 23, 2016

(51) Int. Cl. G06F 12/0862

(52) U.S. Cl. CPC G06F 12/0862; G06F 2212/6026; G06F 2212/6024; G06F 2212/602

(57) ABSTRACT

A proposed prefetcher may operate at a cache level where accesses are conducted using physical addresses. The proposed prefetcher may include one or more prefetch engines. Similar to conventional prefetchers, a prefetch engines of the proposed prefetcher may train on access patterns of a memory page to predict future accesses and perform prefetches based on the training. But unlike the conventional prefetchers, the trained prefetch engine may be reused for prefetching even when a request for a new page is received without requiring the prefetch engine to be newly trained on the new page. This can lower access latencies and lower cumulative training time.

### FIELD OF DISCLOSURE

The field of the disclosed subject matter generally relates to prefetchers. In particular, the field of the disclosed subject matter relates to reusing trained prefetchers.

### BACKGROUND

Memory prefetch, often referred to as just prefetch, is a mechanism where an anticipated memory location is fetched from memory and stored into processor caches. This minimizes the delay when the location is accessed. The prefetcher is the logic that can generate an address that is to be prefetched into the memory system.

Generally, there are two desired features of a prefetcher—usefulness and timeliness. First, the prefetcher should generate useful prefetches. The prefetcher should accurately predict which regions of memory would be accessed and only bring those in. Each prefetch is an access to the memory which consumes power. Additionally, prefetching consumes bandwidth and thus can cause performance drops in bandwidth constrained multi-threaded processors. Furthermore, not fetching the correct page represents a lost performance opportunity.

Second, even if the prefetcher is able to determine the correct addresses for prefetches, it should do so in a timely fashion. If an actual memory access occurs to a just-predicted prefetch address, there is no performance benefit from using the prefetcher. These are often referred to as late prefetches. Early prefetches can also be problematic. For example, if a prefetch occurs too early, that data may be overwritten from the caches due to other memory accesses or prefetches. Since the data is written to the caches, prefetching too early can overwrite useful data, and thus can hurt performance. While an ideal timing would be to have the prefetch delivered exactly when the target memory is required, it is generally better to err towards a late-prefetch than an early-prefetch.

There are two basic types of prefetchers—the MAS (Memory Access Stride) and the IPS (Instruction Pointer Stride). The prefetchers in the MAS category train on eligible accesses to the LLC (last level cache) and train on the stride of the eligible accesses. These eligible accesses are usually what would have missed the LLC if not for the prefetcher (i.e., LLC misses and prefetched memory hits). A more advanced version referred to as AMPM (Access Map Pattern Matching) prefetcher attempts to detect a pattern of accessed cache lines to estimate the next useful prefetch.

The prefetchers in the IPS category train on the instruction pointer (IP) of a load generating the misses. The stride or stride pattern of that load are detected to generate a prefetch. IP is a distinguishing quality of a load and there can be other ways of distinguishing a load. However, the IPS type prefetchers require additional information to be provided with every LLC access.

Other prefetcher designs may be viewed as being various combinations of the MAS and IPS prefetcher types. While many prefetch designs do exist, a significant portion of these conventional prefetchers fetch data into the LLC. As an illustration, in a CPU with L1 and L2 caches, L2 cache would be the LLC. At the LLC stage, all accesses are typically in the physical address space. Generally, the information about the physical page mapped to the next logical page is not known at this level, and so, generated prefetch addresses are limited to the physical page. Otherwise, bus errors can be generated and security issues can arise.

### SUMMARY

This summary identifies features of some example aspects, and is not an exclusive or exhaustive description of the disclosed subject matter. Whether features or aspects are included in, or omitted from this Summary is not intended as indicative of relative importance of such features. Additional features and aspects are described, and will become apparent to persons skilled in the art upon reading the following detailed description and viewing the drawings that form a part thereof.

An exemplary prefetcher is disclosed. The prefetcher may comprise one or more prefetch engines. At least one of the prefetch engines may comprise a current page tag, a communication interface and a prefetch logic. The current page tag may be configured to indicate a page of memory currently accessible by the prefetch engine for servicing access requests. The communication interface may be configured to receive an access request. The access request may comprise a request address, and the request address may comprise a request page and a request offset. The prefetch logic may be configured to determine whether the access request is a request for the current page. The prefetch logic may also be configured to generate a prefetch address based on the request address when the access request is the request for the current page. The prefetch address may comprise a prefetch page and a prefetch offset. The prefetch logic may be further configured to determine whether the prefetch address is an address of the current page and to determine a state of a promote flag. When the prefetch address is not the address of the current page and when the promote flag is FALSE, the prefetch logic may be configured to set the promote flag to TRUE and to store the prefetch offset as an initial promote offset in a promote offset register.

An exemplary method of reusing a prefetch engine is disclosed. The method may comprise receiving, at the prefetch engine, an access request. The access request may comprise a request address, and the request address may comprise a request page and a request offset. The method may also comprise determining whether the access request is a request to access a current page. The current page may be a page of memory currently accessible by the prefetch engine for servicing access requests. The method may further comprise generating a prefetch address based on the request address when the access request is a request for the current page. The prefetch address may comprise a prefetch page and a prefetch offset. The method may additionally comprise determining whether the prefetch address is an address of the current page and determining whether the prefetch engine is eligible for promotion. When the prefetch address is not the address of the current page and when the prefetch engine not eligible for promotion, the method may comprise setting a promotion eligibility of the prefetch engine and storing the prefetch offset as an initial promote offset.

An exemplary prefetcher is disclosed. The prefetcher may comprise one or more prefetch engines. At least one of the prefetch engines may comprise means for receiving an access request. The access request may comprise a request address, and the request address may comprise a request page and a request offset. The at least one prefetch engine may also comprise means for determining whether the access request is a request to access a current page. The current page may be a page of memory currently accessible by the prefetch engine for servicing access requests. The at least one prefetch engine may further comprise means for generating a prefetch address based on the request address when the access request is a request for the current page. The prefetch address may comprise a prefetch page and a prefetch offset. The at least one prefetch engine may additionally comprise means for determining whether the prefetch address is an address of the current page and means for determining whether the prefetch engine is eligible for promotion. When the prefetch address is not the address of the current page and when the prefetch engine not eligible for promotion, the at least one prefetch engine may comprise means for setting a promotion eligibility of the prefetch engine and means for storing the prefetch offset as an initial promote offset.

### BRIEF DESCRIPTION OF THE DRAWINGS

The accompanying drawings are presented to aid in the description of examples of one or more aspects of the disclosed subject matter and are provided solely for illustration of the examples and not limitation thereof.

FIG. 1 illustrates an example of a prefetch engine;

FIGS. 2A and 2B illustrate example states of a prefetch engine before and after receiving an initial access request for a current page;

FIGS. 3A and 3B illustrate example states of a prefetch engine before and after receiving a subsequent access request for a current page;

FIGS. 4A and 4B illustrate example states of a prefetch engine before and after receiving an access request for a new page;

FIG. 5 illustrates a flow chart of an example method of reusing trained prefetch engine;

FIG. 6 illustrates an example process of determining whether to a prefetch engine is to be promoted; and

FIG. 7 illustrated examples of devices with a prefetcher integrated therein.

### DETAILED DESCRIPTION

Aspects of the subject matter are provided in the following description and related drawings directed to specific examples of the disclosed subject matter. Alternates may be devised without departing from the scope of the disclosed subject matter. Additionally, well-known elements will not be described in detail or will be omitted so as not to obscure the relevant details.

The word “exemplary” is used herein to mean “serving as an example, instance, or illustration.” Any embodiment described herein as “exemplary” is not necessarily to be construed as preferred or advantageous over other embodiments. Likewise, the term “embodiments” does not require that all embodiments of the disclosed subject matter include the discussed feature, advantage or mode of operation.

The terminology used herein is for the purpose of describing particular examples only and is not intended to be limiting. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, processes, operations, elements, and/or components, but do not preclude the presence or addition of one or more other features, integers, processes, operations, elements, components, and/or groups thereof.

Further, many examples are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects may be embodied in a number of different forms, all of which have been contemplated to be within the scope of the claimed subject matter. In addition, for each of the examples described herein, the corresponding form of any such examples may be described herein as, for example, “logic configured to” perform the described action.

For discussion purposes, a page—whether virtual or physical—may be viewed as a smallest unit of data for memory management. Each page may be a contiguous block (e.g., sequentially addressable) of memory. The length of the page may be fixed. A single entry in a page table may describe a mapping between a logical page and a physical page.

As indicated, conventional prefetchers fetch data into the LLC (last level cache), which is a cache located in the memory hierarchy just before the memory. At the LLC level, all accesses are typically in the physical address space, and the information about the physical page mapped to the next logical page is not known at this level. This can be problematic.

For a thread of execution, a memory access pattern of that thread may be assumed to be consistent. This means that once a prefetcher is trained on the thread's memory access pattern, the prefetcher can predict future memory accesses, i.e., determine future memory addresses based on the training, and prefetch data into the cache for the thread in accordance with the prediction. At the LLC stage, a conventional prefetcher trains on a physical page since most or all accesses within that single page can be assumed to be due to a same thread. Then the conventional prefetcher can accurately predict the future accesses and prefetch the data accordingly as long as the predicted memory address is within the same physical page on which the training takes place.

As an illustration, assume an LLC line size of 128B. Then a 4K page would have 32 cache lines. For a stride of 4, there are possibly seven more access to the page after the first access. To detect a stride of 4, at least two accesses for training are conventionally used. Thus, the conventional prefetcher can predict and generate six prefetches from the page in the best case. When timeliness is accounted for, the number of useful prefetches drastically reduces from the best case. This scenario exists in all prefetches and limits the prefetches to a page boundary to avoid generating bus errors and to ameliorate security issues.

Once the predicted address points to a different physical page, the training cannot be used. Recall that at the LLC level, information on which physical page is mapped to the next logical page is not known. Then when the predicted future access crosses the current page boundary, it is unknown whether the predicted future physical page is mapped to the next logical page. Thus, the conventional prefetcher retrains for every page. As a result, the prefetching efficiency of the conventional prefetchers is limited, e.g., in terms of usefulness and/or timeliness.

But in an aspect, it is proposed to reuse trained prefetchers even when the page boundary is crossed. The proposed prefetcher reuse may be prefetcher-type agnostic. In other words, the proposed reuse technique may be applicable regardless of whether the prefetcher is an MAS type, an IPS type, some combination thereof, or of any other type.

The proposed reuse of trained prefetchers is based on the notion that contiguous logical pages are likely to have similar access patterns, and thus, are likely to have similar prefetch trainings. Generally, two pages are more likely to have similar prefetch training when they are closer to each other logically. Thus, when it is likely that the new page and the current page are logically close to each other, a trained prefetcher may be reused. In an aspect, a trained prefetcher generating prefetches for a current page may be “promoted” to generate prefetches for a new page upon a miss to the current page.

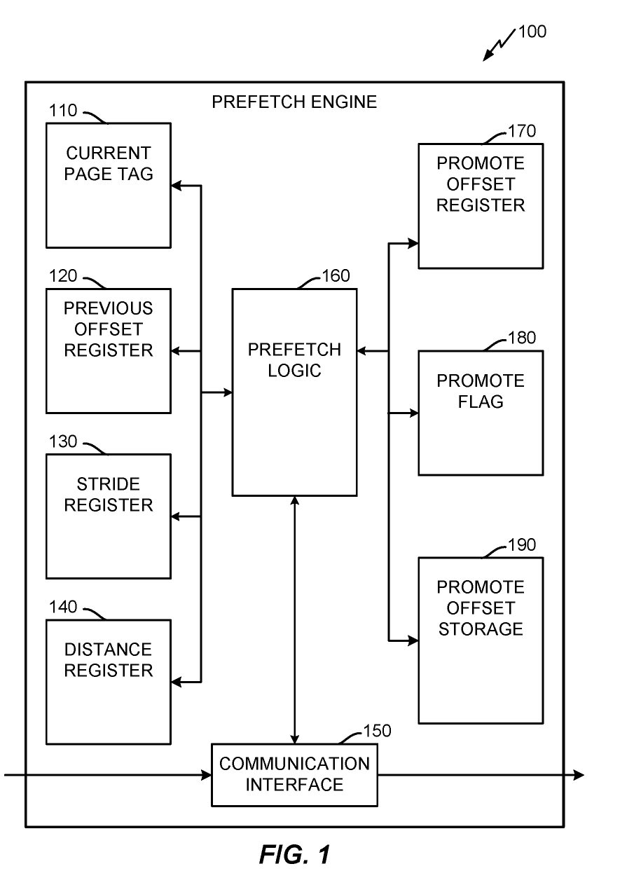

FIG. 1 illustrates a prefetch engine 100. While not illustrated, it should be noted that a prefetcher may include one or more prefetch engines. For example, an L2 level prefetcher may include multiple prefetch engines 100. Each prefetch engine 100 may be trained on a page of system memory. When the prefetcher receives an access request for a page, the prefetch engine 100 that has trained on the requested page may also prefetch data to reduce latency.

The prefetch engine 100 may operate at the LLC. However, the prefetch engine 100 is not so limited to the LLC. The prefetch engine 100 may be applicable to any cache level in which a cache of the level is physically tagged with physical addresses, i.e., addresses that have been translated from virtual addresses.

The prefetch engine 100 may include a current page tag 110 and a previous offset register 120. The current page tag 110 may be configured to indicate a current page, which may be viewed as a page of memory currently accessible by the prefetch engine 100 for servicing access requests. The current page may be a physical page such as a physical page of a system memory. The previous offset register 120 may be configured to hold or indicate an offset of a previous access request.

The prefetch engine 100 may also include a stride register 130 and a distance register 140 configured to hold stride and distance parameters of the current page. Note that the stride and distance are just examples of prefetch parameters that the prefetch engine 100 may use to generate prefetch addresses. While not illustrated, other examples of such prefetch parameters may include address maps used in AMPM types of prefetch engines. In general, prefetch parameters may include any parameters that a prefetch engine 100 may train on to detect access patterns on a page.

The prefetch engine 100 may further include a communication interface 150 configured to receive access requests from a lower level requestor and to send to send prefetch requests to a higher level provider. For example, if the prefetch engine 100 is an engine at an L2 level, the communication interface 150 may receive access requests from an L1 level cache and sent prefetch requests to the system memory. The access request from the lower level requestor may include a request address in which the request address may include a request page and a request offset. The prefetch request to the higher level provider may include a prefetch address in which the prefetch address may include a prefetch page and a prefetch offset. The request address and/or the prefetch address may be physical addresses.

The prefetch engine 100 may additionally include a promote offset register 170, a promote flag 180 and a promote offset storage 190. The promote offset register 170 may be configured to store a promote offset value (or simply promote offset), the promote flag 180 may be configured to indicate whether the prefetch engine 100 is eligible for promotion, and the promote offset storage 190 may be configured to store other promote offset values. The prefetch engine 100 may include a prefetch logic 160 configured to control the operations of the prefetch engine 100.

Each of the elements of the prefetch engine 100—the current page tag 110, the previous offset register 120, the prefetch parameters (e.g., the stride register 130, the distance register 140), the communication interface 150, the prefetch logic 160, the promote offset register 170, the promote flag 180 and the promote offset storage 190 may be implemented in hardware and/or software such that the prefetch engine 100 as a whole is implemented entirely in hardware or in a combination of hardware and software. For example, the prefetch engine 100 may be implemented as part of a system-on-chip (SoC).

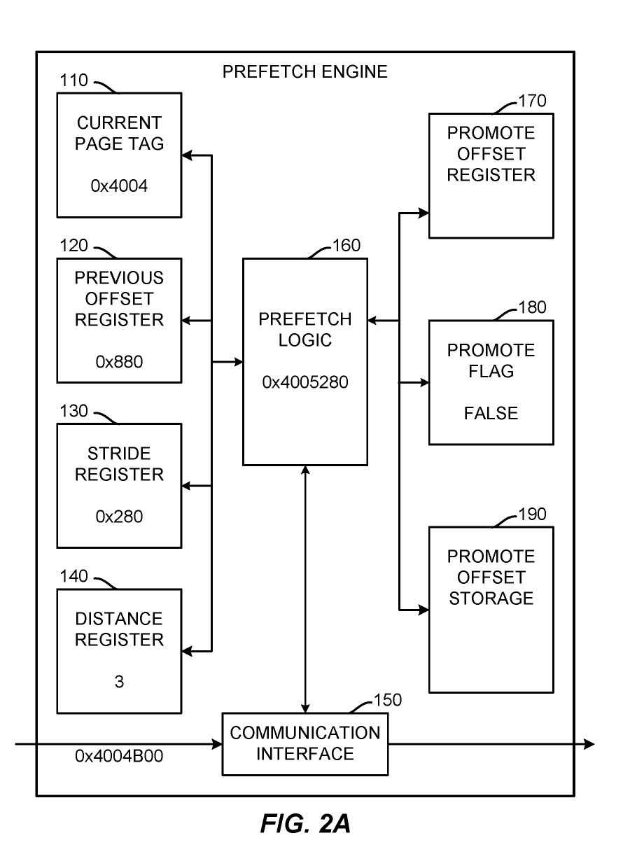

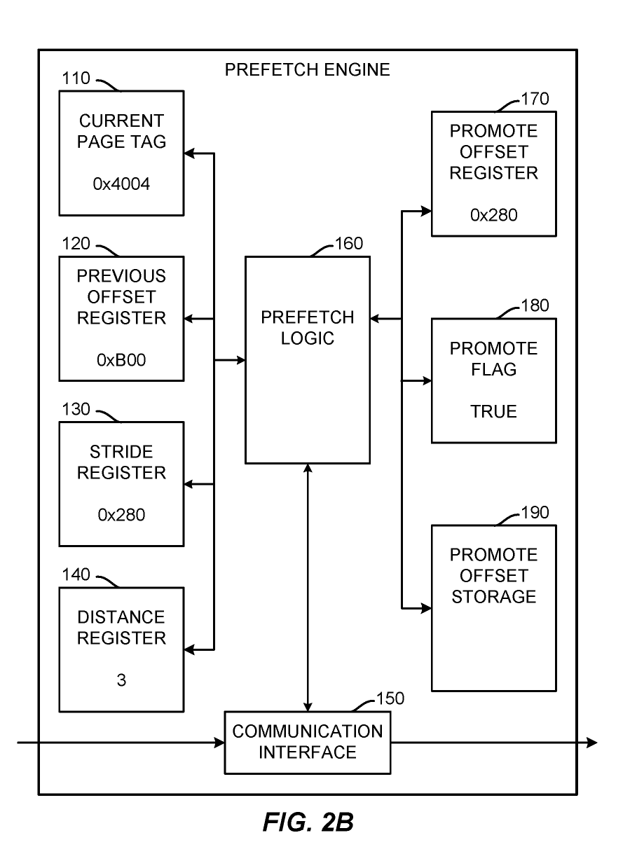

An example reuse of a trained prefetch engine 100 is demonstrated in FIGS. 2A-4B. For demonstration purposes, each address is represented with a seven-digit hexadecimal (indicated with leading 0x) where most significant four digits represent the page and the least significant three digits represent the offset within the page. In these figures, it may be assumed that two consecutive logical pages 0x8000 and 0x8001 are mapped respectively to physical pages 0x4004 and 0x5300.

FIGS. 2A and 2B demonstrates an example effect of a first prefetch that crosses the current page boundary which makes the prefetch engine 100 eligible for promotion, i.e., eligible for reuse. FIG. 2A may illustrate an initial state of the prefetch engine 100 when the communication interface 150 receives an access request, which may be from a lower level requestor. For demonstration purposes, it may be assumed that 0x4004 is stored in the current page tag 110 indicates that the prefetch engine 100 is currently accessing physical page 0x4004 of memory. It may also be assumed that the prefetch engine 100 has been trained on the page 0x4004. For example, the stride and the distance values stored in the stride and distance registers 130, 140 may be based on previous access patterns on the page 0x4004. Again, these are merely examples of prefetch parameters. Depending on the mechanism used to recognize access patterns, appropriate parameters may be stored.

At the initial state, the promote offset register 170 may be empty and the promote flag 180 may be set to FALSE which indicates that the prefetch engine 100 is not eligible for promotion. In an aspect, a single promote register may be used for both to store the promote offset and to indicate the promotion eligibility of the prefetch engine 100. For example, a specific value (e.g., 0xFFF) stored in the single promote register may be used to indicate that the prefetch engine 100 is not promotion eligible, while other values may indicate a valid promotion offset.

In FIG. 2A, it is assumed that the request address 0x4004B00 is received, which can be viewed as including a request page 0x4004 and a request offset 0xB00. Note that the request page and the current page are equal. In other words, the access request is a request for the current page. Under this circumstance, the prefetch logic 160 may generate a prefetch address based on the request address and based on the prefetch parameters. For example, when the stride (0x280) and the distance (3) are applied to the request address (0x4004B00), the prefetch logic 160 may generate 0x4005280 as the prefetch address.

However, the prefetch address 0x4005280 crosses the boundary of the current page. That is, the prefetch page 0x4005 of the generated preface address is not equal to the current page 0x4004. When the prefetch engine 100 is not promotion eligible (e.g., the promote flag 180 is FALSE), the generated prefetch address 0x4005280 may be viewed as the initial prefetch address crossing the current page boundary. In this instance, the prefetch logic 160 may make the prefetch engine 100 eligible for promotion (e.g., by setting the promote flag 180 to TRUE) and store the prefetch offset 0x280 as the initial promote offset (e.g., by storing 0x280 in the promote offset register 170). This is illustrated in FIG. 2B.

Since the prefetch address 0x4005280 crosses the page boundary, no prefetch is actually performed. That is, the prefetch logic 160 does not prefetch data based on the prefetch address 0x4005280 from the higher level provider. For example, if the prefetch engine 100 is part of an LLC, the prefetch logic 160 would not prefetch data from the physical system memory address 0x4005280.

For completeness, FIG. 2B illustrates that the previous offset register 120 is updated with the request offset 0xB00. Also, while not specifically illustrated, when the access request page is a request for the current page (e.g., the request and current pages are equal), this represents an opportunity to continue training on the current page. For example, the prefetch logic 160 may update the prefetch parameters (e.g., the stride and/or distance registers 130, 140) based on the request address and based on a history of past request addresses to the current page to make future predictions more accurate.

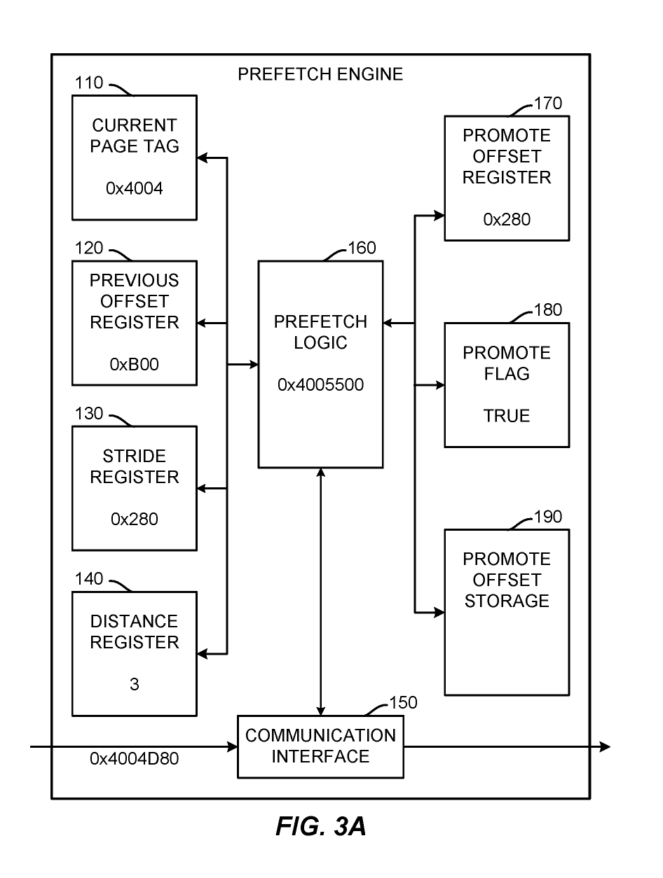

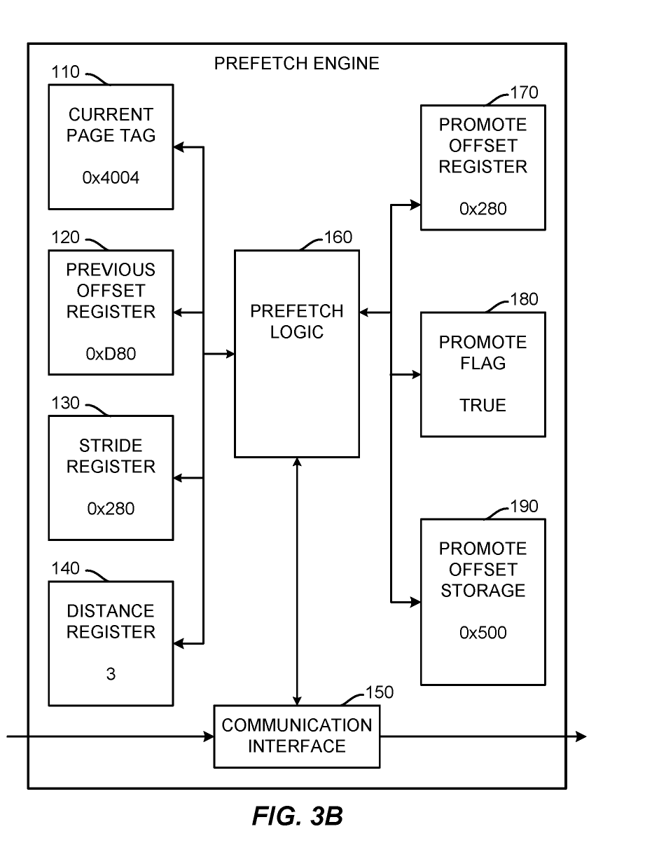

FIGS. 3A and 3B demonstrates an example effect of subsequent prefetch addresses that cross the page boundary. Generally, the offsets of such subsequent prefetch addresses are also stored. FIG. 3A illustrate an example state of the prefetch engine 100 when the communication interface 150 subsequently receives an access request with request address 0x4004B00. Since this is also a request for the current page (request and current pages are both 0x4004), the prefetch logic 160 may generate a prefetch address 0x4005500 based on the subsequent request address and based on the prefetch parameters.

Note that the subsequently generated prefetch address 0x4005500 also crosses the boundary of the current page. This again means that no prefetch is actually performed. But in this instance, the prefetch engine 100 is now promotion eligible (e.g., the promote flag 180 is TRUE). This indicates that other prefetch addresses that crossed the page boundary have been generated before. In this instance, the prefetch logic 160 may store the prefetch offset 0x500 as an additional promote offset (e.g., by storing 0x500 in the promote offset storage 190). This is illustrated in FIG. 3B. If there are more access requests to the current page that results in more out of boundary prefetch address being generated, the corresponding offsets may also be stored as additional promote offsets in the promote offset storage 190.

In an aspect, the promote offset storage 190 may be implemented as a FIFO storage. In another aspect, the promote offset register 170 may be a specific location of the promote offset storage 190. For example, promote offset register 170 may be the first storage location of the FIFO storage.

Again for completeness, FIG. 3B illustrates that the previous offset register 120 may now be updated with the request offset 0xD80. Also, since the subsequent access request is a request for the current page, the prefetch logic 160 may update the prefetch parameters.

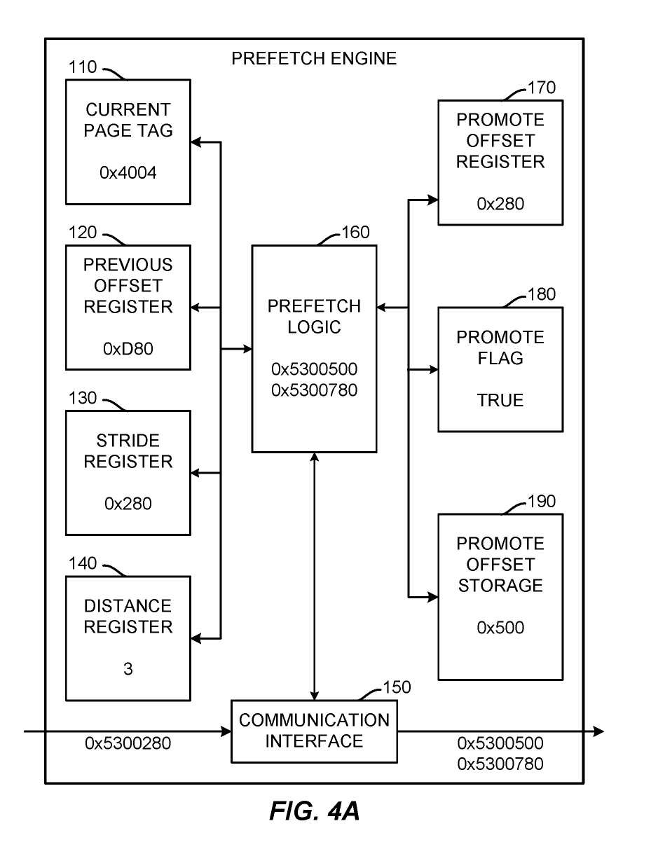

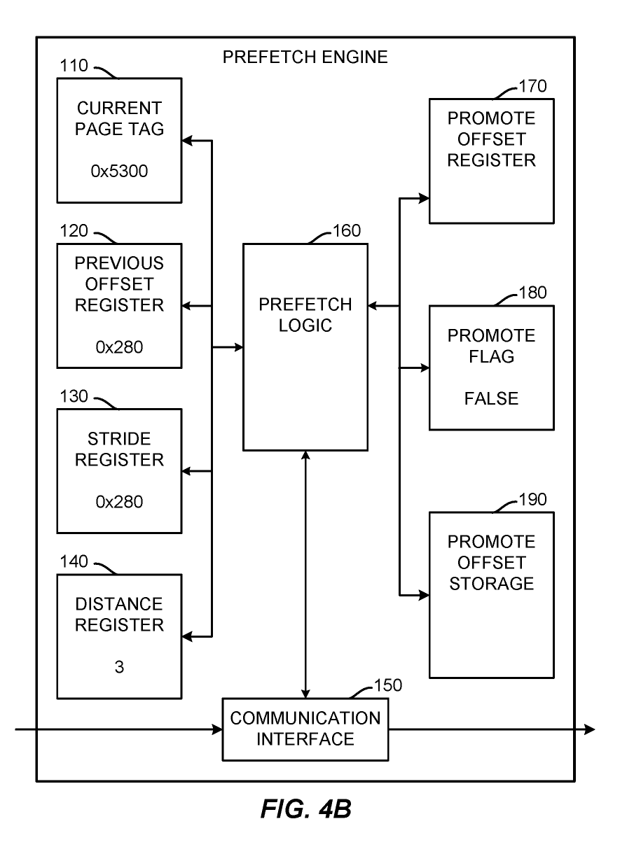

FIGS. 4A and 4B demonstrates an example effect when the prefetch engine 100 receives a request for a new page. Generally, when this occurs, the prefetch engine 100 may be promoted for reuse depending on one or more conditions. If the prefetch engine 100 is promoted, then current page may be updated to the new page and the prefetch engine 100 may perform prefetches on the new page based on the prefetch parameters of the old page.

FIG. 4A illustrates an example of a state of the prefetch engine 100 when the communication interface 150 subsequently receives an access request with request address 0x5300280, which is a request for a new page (e.g., the request page 0x5300 and the current page 0x4004 are not equal). Under this circumstance, the prefetch logic 160 may determine whether the prefetch engine 100 is promotion eligible, e.g., may determine whether the promote flag 180 is TRUE.

If the prefetch engine 100 is promotion eligible, then the prefetch logic 160 may determine whether to actually promote the prefetch engine 100 for reuse. In an aspect, if the initial promote offset stored in the promote offset register 170 equals the request offset, it may be decided to promote the prefetch engine 100. Note that the initial promote offset represents a predicted offset within a next logical page 0x8001. If the offset of the incoming new page access request, the likelihood of the new page being mapped to the next logical page may be high. In this instance, the training represented in the prefetch parameters (e.g., stride and distance) may be reused for prefetches. This can lower memory latencies and also reduce cumulative training time.

In another aspect, the prefetch engine 100 may be promoted when the new page is within a threshold number of pages of the current page. Preferably the direction of the prediction is taken into account. For example, if the stride is positive and the threshold number is one, then the prefetch engine 100 may be promoted if the new page is the next page. As another example, if the stride is negative and the threshold number is two, then the prefetch engine 100 may be promoted if the new page is within two previous pages of the current page. In yet another aspect, the prefetch engine 100 may be promoted if there are no other prefetch engines 100 free for the new page.

Note that a combination of conditions may be used. For example, it may be first checked whether the initial promote offset stored in the promote offset register 170 equals the request offset of the new page. If this first test succeeds, the prefetch engine 100 may be promoted. If not, then it may be checked whether the new page is within the threshold number of pages. If this second test succeeds, the prefetch engine 100 may be promoted. If not, then it may be checked whether there are no other prefetch engines 100 free. If this third test succeeds (no other free prefetch engines 100), the prefetch engine 100 may be promoted. Otherwise, i.e., when all tests fail, the prefetch engine 100 may not be promoted.

If it is decided to promote the prefetch engine 100, then the prefetch logic 160 may update the current page tag 110 to the new page 0x5300 and reset the promotion eligibility, i.e., set the promote flag 180 to FALSE. This is illustrated in FIG. 4B. But in addition, the prefetch logic 160 may generate a prefetch address 0x5300780 based on the request address 0x5300280 and based on the prefetch parameters. Since the generated prefetch address 0x5300780 is within the current page 0x5300, the prefetch logic 160 may prefetch data from the higher level provider (e.g., system memory) based on the prefetch address 0x5300780. This is illustrated in FIG. 4A which shows the communication interface 150 providing the address 0x5300780 to the higher level provider for prefetch.

Also when there are additional promote offsets stored in the promote offset storage 190, the prefetch logic 160 may prefetch data from the higher level provider based on each additional promote offset. This is also illustrated in FIG. 4A which shows the communication interface 150 providing the address 0x5300500, which is based on the additional promote offset 0x500, to the higher level provider for prefetch. Prefetching based on the additional promote offsets increases the degree of prefetch. That is, in a non-limiting aspect, a single new page request may trigger multiple prefetches of data.

It is important to realize that when the prefetch engine 100 is promoted, the training that took place on the old page is reused for the new page. The prefetch engine 100 does not restart training when a new page is encountered. Instead, the prefetch parameters (e.g., stride, distance, access map, etc.) may be left unmodified at least between when the access request for the new page is received and when the prefetch address is generated. For example, in the circumstance illustrated in FIG. 4A in which the prefetch engine 110 is promoted, it is not required to perform training to determine the prefetch parameter values (e.g., stride, distance) prior to generating the initial prefetch address 0x5300780. Rather, the initial prefetch address 0x5300780 may be generated based on the existing stride and distance parameter values. Thus, at least for the initial prefetch address 0x5300780, previous training that determined the existing prefetch parameters may be reused in generating the initial prefetch address 0x5300780, and the associated data may be prefetched thereafter. If additional promote offsets are stored in the promote offset storage 190, the corresponding prefetch addresses may also be generated (e.g., prefetch address 0x5300500) and the associated data may be prefetched.

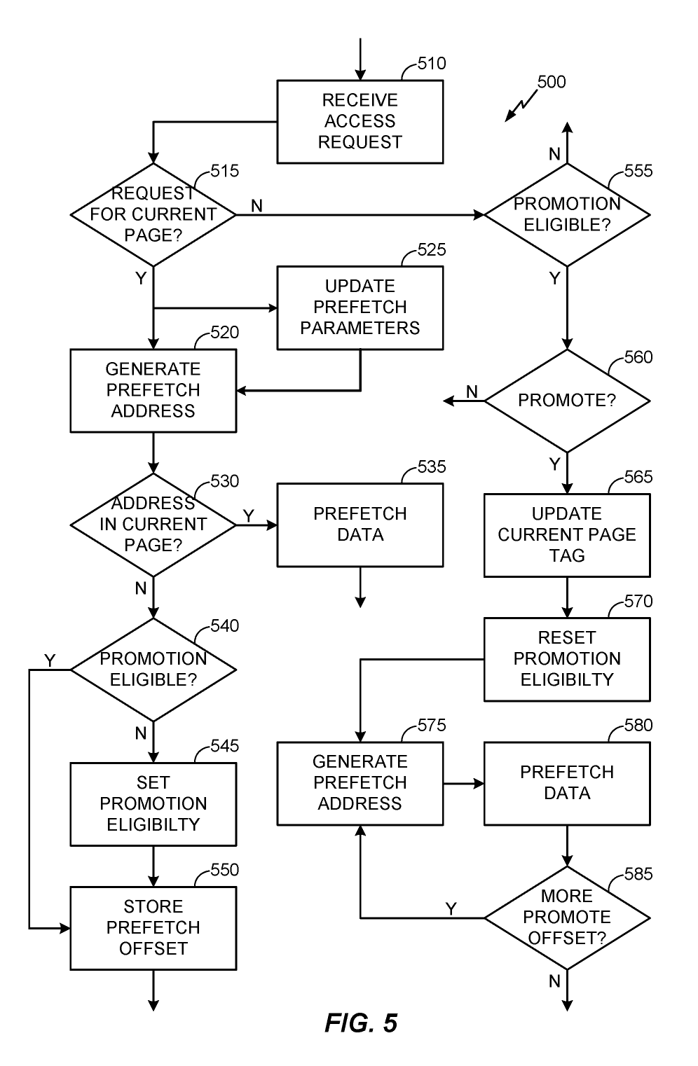

FIG. 5 illustrates a flow chart of an example method 500 of reusing a trained prefetch engine 100. It should be noted that not all illustrated blocks of FIG. 5 need to be performed, i.e., some blocks may be optional. Also, the numerical references to the blocks of the FIG. 5 should not be taken as requiring that the blocks should be performed in a certain order.

In block 510, the communication interface 150 may receive an access request. The access request may comprise a request address, and the request address may comprise a request page and a request offset. The communication interface 150 may be an example of means for receiving an access request.

In block 515, the prefetch logic 160 may determine whether the access request is a request for the current page. For example, the prefetch logic 160 may determine whether the request page and the current page stored in the current page tag 110 are equal. The prefetch logic 160 may be an example of means for determining whether the access request is a request for the current page, and the current page tag 110 may be an example of means for storing the current page.

In block 520, the prefetch logic 160 may generate a prefetch address based on the request address when the access request is a request for the current page. The prefetch address may be generated also based on one or more parameters including (e.g., stride, distance, address map). The prefetch address may comprise a prefetch page and a prefetch offset. The prefetch logic 160 may be an example of means for generating the prefetch address.

In block 525, the prefetch logic 160 may also update the prefetch parameters when the access request is a request for the current page. In other words, the prefetch logic 160 may further refine the training on the current page when such opportunities occur. The prefetch logic 160 may be an example of means for updating the prefetch parameters.

In block 530, the prefetch logic 160 may determine whether the generated prefetch address is an address of the current page. For example, the prefetch logic 160 may compare the current page with the prefetch page and determine whether they are equal. The prefetch logic 160 may be an example of means for determining whether the generated prefetch address is an address of the current page.

In block 535, the prefetch logic 160 may prefetch data from the higher level provider when the prefetch address is an address of the current page. The data may be prefetched based on the prefetch address. The prefetch address may be provided to the higher level provider by the communication interface 150. The prefetch logic 160 may be an example of means for prefetching data from the higher level provider, and the communication interface 150 may be an example of means for providing prefetch requests.

In block 540, when the prefetch address is not an address of the current page, i.e., when the prefetch address crosses the current page boundary, the prefetch logic 160 may determine whether the prefetch engine 100 is eligible for promotion. For example, the prefetch engine 100 may determine whether the promote flag 180 is TRUE. The prefetch logic 160 may be an example of means for determining whether the prefetch engine 100 is eligible for promotion and the promote flag 180 may be an example of means for indicating a promotion eligibility.

When the prefetch address is not an address of the current page (e.g., when the current page and the prefetch page are not equal) and the prefetch engine 100 is not eligible for promotion (e.g., when the promote flag 180 is FALSE), the prefetch logic 160 may set the promotion eligibility of the prefetch engine 100 (e.g., set the promote flag 180 to TRUE) in block 545, and may also store the prefetch offset as an initial promote offset (e.g., in the promote offset register 170) in block 550.

On the other hand, when the prefetch address is not an address of the current page but the prefetch engine 100 is eligible for promotion, the prefetch logic 160 may store the prefetch offset as an additional promote offset (e.g., in the promote offset storage 190) in block 550. The prefetch logic 160 may be an example of means for setting/resetting the promotion eligibility of the prefetch engine, and the promote offset storage 190 may be an example of means for storing one or more additional promote offsets.

When it is determined in block 515 that the access request is not a request for the current page (the request is for a new page), then in block 555, the prefetch logic 160 may determine whether the prefetch engine 100 is eligible for promotion (e.g., determine whether the promote flag 180 is TRUE). The prefetch logic 160 may be an example of means for determining the promotion eligibility of the prefetch engine 100.

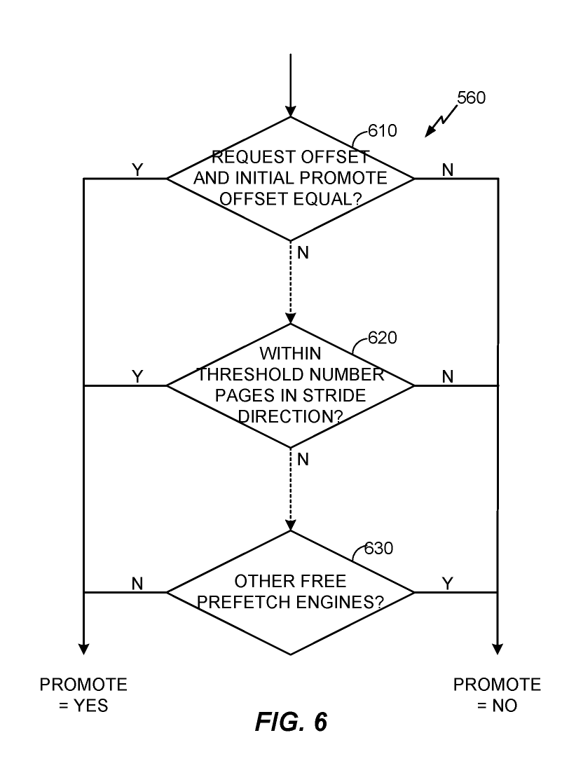

In block 560, the prefetch logic 160 may determine whether to actually promote the prefetch engine 100 when it is determined that the prefetch engine 100 is promotion eligible. FIG. 6 illustrates an example process to perform the block 560. In block 610, the prefetch logic 160 may determine whether the initial promote offset stored in the promote offset register 170 and the request offset are equal. Note that the request offset is the offset of request address of the new page. If the offsets are equal, it may be that the new page and the old pages are logically close, and thus the prefetch engine 100 may be promoted. If not, it may be decided to not promote the prefetch engine 100.

Alternatively, if the initial promote offset and the request offset are not equal, then in block 620, the prefetch logic 160 may determine whether the new page is within a threshold number of pages of the current page in a direction of a stride. If so, the prefetch engine 100 may be promoted. If not, it may be decided to not promote the prefetch engine 100.

Also alternatively, if the new page is not within the threshold number of pages of the current page, then in block 630, the prefetch logic 160 may determine whether there are any other free prefetch engines 100. If there are no other free prefetch engines 100, then the prefetch engine 100 may be promoted. If there are other free prefetch engines 100, it may be decided to not promote the prefetch engine 100. This can allow another free prefetch engine 100 to train and prefetch on the new page. The prefetch logic 160 may an example of means for determining whether to promote the prefetch engine 100.

Referring back to FIG. 5, when it is determined to promote the prefetch engine 100, the prefetch logic 160 may update the current page with the request page (e.g., update the current page tag 110) in block 565, make the prefetch engine 100 ineligible for promotion (e.g., reset the promote flag 180 to FALSE) in block 570, generate a prefetch address based on the request address and the prefetch parameters in block 575, and prefetch data from the higher level provider based on the generated prefetch address in block 580. If the prefetch logic 160 determines that there are additional promote offsets (e.g., in the promote offset storage 190) in block 585, the prefetch logic 160 may repeat blocks 575 and 580 for each additional promote offset. The prefetch logic 160 may be an example of means for updating the current page to the request page, means for resetting the promotion eligibility of the prefetch engine 100, means for generating the prefetch address, and means for prefetching data from a higher level provider.

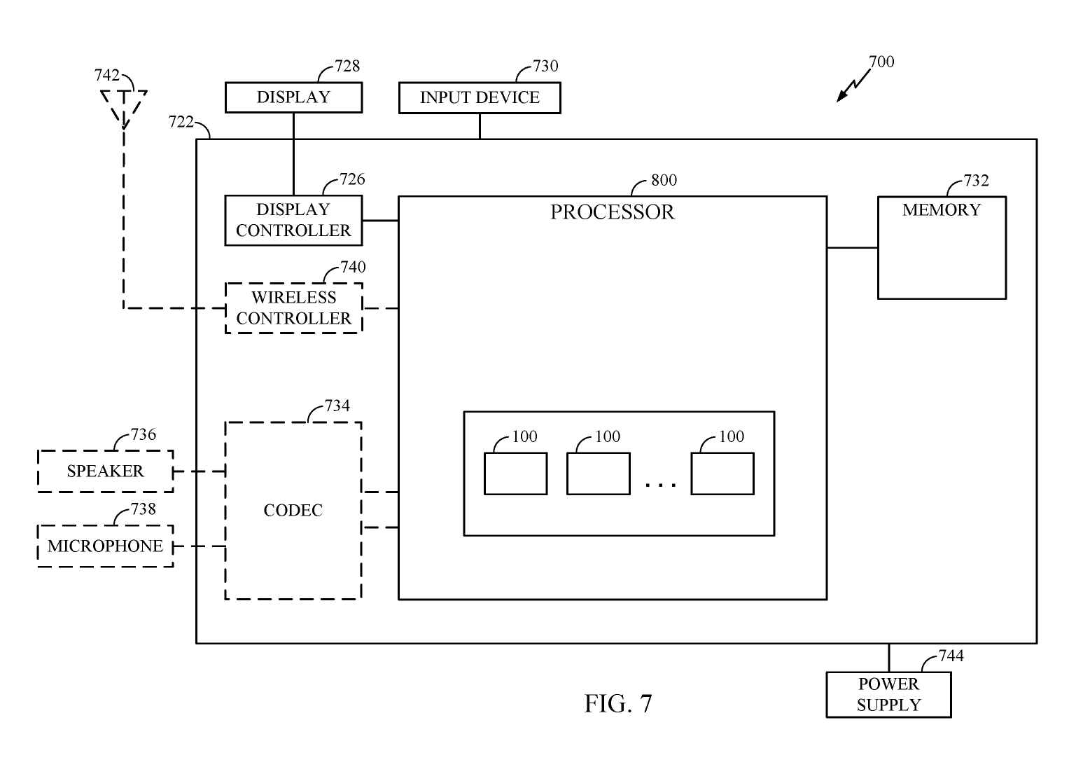

Referring now to FIG. 7, a block diagram of a computing device that is configured according to exemplary aspects is depicted and generally designated 700. In some aspects, the computing device 700 may be configured as a wireless communication device. As shown, the computing device 700 includes processor 800 with a prefetcher with one or more prefetch engines 100 of FIG. 1 with at least one prefetch engine 100 configured to implement method 500 of FIG. 5 in some aspects. Processor 800 may be communicatively coupled to memory 732. Computing device 700 also include display 728 and display controller 726, with display controller 726 coupled to processor 800 and to display 728.

In some aspects, FIG. 7 may include some optional blocks showed with dashed lines. For example, computing device 700 may optionally include coder/decoder (CODEC) 734 (e.g., an audio and/or voice CODEC) coupled to processor 100; speaker 736 and microphone 738 coupled to CODEC 734; and wireless controller 740 (which may include a modem) coupled to wireless antenna 742 and to processor 800.

In a particular aspect, where one or more of the above-mentioned optional blocks are present, processor 800, display controller 726, memory 732, CODEC 734, and wireless controller 740 can be included in a system-in-package or system-on-chip device 722. Input device 730, power supply 744, display 728, input device 730, speaker 736, microphone 738, wireless antenna 742, and power supply 744 may be external to system-on-chip device 722 and may be coupled to a component of system-on-chip device 722, such as an interface or a controller.

It should be noted that although FIG. 7 depicts a computing device, processor 800 and memory 732 may also be integrated into a set top box, a music player, a video player, an entertainment unit, a navigation device, a personal digital assistant (PDA), a fixed location data unit, a server, a computer, a laptop, a tablet, a communications device, a mobile phone, or other similar devices.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithms described in connection with the examples disclosed herein may be implemented as electronic hardware, computer software, or combinations of both. To clearly illustrate this interchangeability of hardware and software, various illustrative components, blocks, modules, circuits, and methods have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The methods, sequences and/or algorithms described in connection with the examples disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an aspect can include a computer readable media embodying a method of forming a semiconductor device. Accordingly, the scope of the disclosed subject matter is not limited to illustrated examples and any means for performing the functionality described herein are included.

While the foregoing disclosure shows illustrative examples, it should be noted that various changes and modifications could be made herein without departing from the scope of the disclosed subject matter as defined by the appended claims. The functions, processes and/or actions of the method claims in accordance with the examples described herein need not be performed in any particular order. Furthermore, although elements of the disclosed subject matter may be described or claimed in the singular, the plural is contemplated unless limitation to the singular is explicitly stated.

What is claimed is:

1. A prefetcher comprising one or more prefetch engines, at least one prefetch engine comprising:
a current page tag configured to indicate a current page, the current page being a page of memory currently accessible by the prefetch engine for servicing access requests;
a communication interface configured to receive an access request comprising a request address, the request address comprising a request page and a request offset; and
a prefetch logic configured to:
determine whether the access request is a request for the current page;
generate a prefetch address based on the request address and on one or more prefetch parameters when the access request is the request for the current page, the prefetch address comprising a prefetch page and a prefetch offset;
determine whether the prefetch address is an address of the current page;
determine a state of a promote flag; and
set the promote flag to TRUE and store the prefetch offset as an initial promote offset in a promote offset register when the prefetch address is not the address of the current page and the promote flag is FALSE.

2. The prefetcher of claim 1, wherein the current page is a physical page and the request address is a physical address.

3. The prefetcher of claim 1, wherein the prefetch logic is configured to update the one or more prefetch parameters when the access request is the request for the current page.

4. The prefetcher of claim 1, wherein the prefetch logic is configured to:
determine whether the prefetch engine is to be promoted when the access request is not the request for the current page and the promote flag is TRUE, and
when it is determined that the prefetch engine is to be promoted,
update the current page tag to the request page;
reset the promote flag to FALSE;
generate the prefetch address based on the request address; and
prefetch data based on the prefetch address.

5. The prefetcher of claim 4, wherein none of the one or more prefetch parameters are modified between when the communication interface receives the access request and when the prefetch logic generates the prefetch address.

6. The prefetcher of claim 4, wherein the prefetch logic is configured to determine that the prefetch engine is to be promoted
when the request offset equals the initial promote offset,
when the access request is for a page that is within a threshold number of pages in a direction of a stride, and/or
when there are no other free prefetch engines.

7. The prefetcher of claim 1,
wherein the at least one prefetch engine further comprises a promote offset storage, and
wherein the prefetch logic is configured to store the prefetch offset in the promote offset storage as an additional promote offset when the prefetch address is not an address of the current page and the promote flag is TRUE.

8. The prefetcher of claim 7, wherein the prefetch logic is configured to:
determine whether the prefetch engine is to be promoted when the access request is not the request for the current page and the promote flag is TRUE; and
when it is determined that the prefetch engine is to be promoted,
update the current page tag to the request page;
reset the promote flag to FALSE;
generate the prefetch address based on the request address;
prefetch data based on the prefetch address, and
for each additional promote offset,
generate the prefetch address based on that additional promote offset and the updated current page, and
prefetch data based on the prefetch address.

9. The prefetcher of claim 8, wherein none of the one or more prefetch parameters are modified between when the communication interface receives the access request and when the prefetch logic generates the prefetch address.

10. The prefetcher of claim 8, wherein the prefetch logic is configured to determine that the prefetch engine is to be promoted
when the request offset equals the initial promote offset,
when the access request is for a page that is within a threshold number of pages in a direction of a stride, and/or
when there are no other free prefetch engines.

11. A method of reusing a prefetch engine of a prefetcher, the method comprising:
receiving, at the prefetch engine, an access request comprising a request address, the request address comprising a request page and a request offset;
determining whether the access request is a request to access a current page, the current page being a page of memory currently accessible by the prefetch engine for servicing access requests;
generating a prefetch address based on the request address and on one or more prefetch parameters when the access request is a request for the current page, the prefetch address comprising a prefetch page and a prefetch offset;
determining whether the prefetch address is an address of the current page;
determining whether the prefetch engine is eligible for promotion; and
setting a promotion eligibility of the prefetch engine and storing the prefetch offset as an initial promote offset when the prefetch address is not the address of the current page and the prefetch engine not eligible for promotion.

12. The method of claim 11, wherein the current page is a physical page and the request address is a physical address.

13. The method of claim 11, wherein the method further comprises updating (525) the one or more prefetch parameters when the access request is the request for the current page.

14. The method of claim 11, further comprising:
determining whether the prefetch engine is eligible for promotion when the access request is not the request for the current page;
determining whether the prefetch engine is to be promoted when the prefetch engine is eligible for promotion; and
when it is determined that the prefetch engine is to be promoted,
updating the current page to the request page;
resetting the promotion eligibility of the prefetch engine;
generating the prefetch address based on the request address; and
prefetching data based on the prefetch address.

15. The method of claim 14, wherein none of the one or more prefetch parameters are modified between receiving the access request and generating the prefetch address.

16. The method of claim 14, wherein determining whether the prefetch engine is to be promoted comprises:
determining that the prefetch engine is to be promoted when the request offset equals the initial promote offset;
determining that the prefetch engine is to be promoted when the access request is for a page that is within a threshold number of pages in a direction of a stride; and/or
determining that the prefetch engine is to be promoted when there are no other free prefetch engines.

17. The method of claim 11, further comprising storing the prefetch offset as an additional promote offset when the prefetch address is not an address of the current page and the prefetch engine is eligible for promotion.

18. The method of claim 17, further comprising:
determining whether the prefetch engine is eligible for promotion when the access request is not the request for the current page;
determining whether the prefetch engine is to be promoted when the prefetch engine is eligible for promotion; and
when it is determined that the prefetch engine is to be promoted,
updating the current page to the request page;
resetting the promotion eligibility of the prefetch engine;
generating the prefetch address based on the request address;
prefetching data based on the prefetch address; and
for each additional promote offset,
generating the prefetch address based on that additional promote offset and the updated current page; and
prefetching data based on the prefetch address.

19. The method of claim 18, wherein none of the one or more prefetch parameters are modified between receiving the access request and generating the prefetch address.

20. The method of claim 18, wherein determining whether the prefetch engine is to be promoted comprises any of the following:
determining that the prefetch engine is to be promoted when the request offset equals the initial promote offset;
determining that the prefetch engine is to be promoted when the access request is for a page that is within a threshold number of pages in a direction of a stride; and
determining that the prefetch engine is to be promoted when there are no other free prefetch engines.

21. A prefetcher comprising one or more prefetch engines, at least one prefetch engine, comprising:
means for receiving an access request comprising a request address, the request address comprising a request page and a request offset;
means for determining whether the access request is a request to access a current page, the current page being a page of memory currently accessible by the prefetch engine for servicing access requests;
means for generating a prefetch address based on the request address and on one or more prefetch parameters when the access request is a request for the current page, the prefetch address comprising a prefetch page and a prefetch offset;
means for determining whether the prefetch address is an address of the current page;
means for determining whether the prefetch engine is eligible for promotion; and
means for setting a promotion eligibility of the prefetch engine and means for storing the prefetch offset as an initial promote offset when the prefetch address is not the address of the current page and the prefetch engine not eligible for promotion.

22. The prefetcher of claim 21, further comprising:
means for determining whether the prefetch engine is eligible for promotion when the access request is not the request for the current page;
means for determining whether the prefetch engine is to be promoted when the prefetch engine is eligible for promotion; and
when it is determined that the prefetch engine is to be promoted,
means for updating the current page to the request page;
means for resetting the promotion eligibility of the prefetch engine;
means for generating the prefetch address based on the request address; and
means for prefetching data based on the prefetch address.

23. The prefetcher of claim 1, wherein the prefetcher is incorporated into a computing device integrated into any one or more of a set top box, a music player, a video player, an entertainment unit, a navigation device, a personal digital assistant (PDA), a fixed location data unit, a server, a computer, a laptop, a tablet, a communications device, and a mobile phone.
